(19) United States
(12) Patent Application Publication
(10) Pub. No.: US 2013/0265575 A1
(43) Pub. Date: Oct. 10, 2013

(54) DETECTION APPARATUS, LITHOGRAPHY APPARATUS, CHARGED PARTICLE BEAM APPARATUS, AND ARTICLE MANUFACTURING METHOD

(71) Applicant: CANON KABUSHIKI KAISHA, Tokyo (JP)

(72) Inventors: Wataru Yamaguchi, Utsunomiya-shi (JP); Hideki Ina, Tokyo (JP)

(73) Assignee: CANON KABUSHIKI KAISHA, Tokyo (JP)

(21) Appl. No.: 13/853,843

(22) Filed: Mar. 29, 2013

(30) Foreign Application Priority Data
Apr. 4, 2012 (JP) 2012-085725

(51) Int. Cl. G01N 21/23; G01B 11/26

(52) U.S. Cl. CPC G01N 21/23; G01B 11/26
USPC 356/365; 355/73

(57) ABSTRACT

A detection apparatus includes an optical system including a polarization beam splitter and a quarter-wave plate. The optical system illuminates a mark via the polarization beam splitter and the quarter-wave plate in sequence, and directs light reflected from the mark via the quarter-wave plate and the polarization beam splitter in sequence towards a light-receiving element An airtight container configured to enclose therein at least part of the optical system includes, as a partition wall thereof, a light transmitting member arranged in an optical path between the polarization beam splitter and the quarter-wave plate.

### BACKGROUND OF THE INVENTION

1. Field of the Invention

The present invention relates to a detection apparatus, a lithography apparatus, a charged particle beam apparatus, and an article manufacturing method.

2. Description of the Related Art

An exposure apparatus (lithography apparatus) is used to manufacture a semiconductor element such as a memory chip or a logic circuit. The exposure apparatus has a detection apparatus for measuring the position of an alignment mark formed on a substrate such as a semiconductor wafer, and the like. Japanese Patent Application Laid-Open No. 63-229305 discusses a detection apparatus in which a polarizing beam splitter transmits P-polarized light from an illumination optical system and the transmitted P-polarized light becomes circularly polarized light through a λ/4 plate and the circularly polarized light illuminates the mark formed on the substrate through an objective optical system. In addition, reflection light from the mark passes through the objective optical system and passes through the λ/4 plate to become S-polarized light and the S-polarized light is reflected by a polarization beam splitter and is detected by a light-receiving element. This configuration is advantageous in improving signal-to-noise (S/N) ratio of a detected signal because illumination light and reflection light are separated by using the polarization beam splitter and the λ/4 plate.

In recent years, with an increased demand for smaller circuit patterns of a semiconductor element, a lithography apparatus using extreme ultra violet (EUV) light or charged particle beam such as an electron beam has been discussed. The EUV light or the charged particle radiation is characterized in that the EUV light or the charged particle beam is absorbed and decayed under an atmospheric environment. To that end, the lithography apparatus using an EUV light or charged particle beam includes a vacuum chamber to provide a high vacuum environment in which atmospheric pressure is 10⁻⁴ Pascals (Pa) or lower. Accordingly, a detection apparatus described in Japanese Patent Application Laid-Open No. 63-229305 also needs to be arranged in a vacuum chamber. However, Japanese Patent Application Laid-open No. 63-229305 does not describe that the detection apparatus is arranged in the vacuum chamber, or the components required for such arrangement.

In a detection apparatus (optical system) of Japanese Patent Application Laid-open No. 2007-48881, an airtight container arranged in a vacuum chamber and including a transparent plate transmitting light covers components (a light source, a camera, a cemented lens, and the like) that generate a contamination material. This configuration is advantageous in maintaining a required vacuum atmosphere.

However, like Japanese Patent Application Laid-open No. 2007-48881, when a light transmitting member of the airtight container is present in an optical path which is common to illumination of the mark and light receiving of the reflection light from the mark, the reflection light from the light transmitting member may be incident on the light-receiving element. As a result, it may be disadvantageous in an S/N ratio of the signal detected by the light-receiving element.

### SUMMARY OF THE INVENTION

The present invention is directed to, for example, a detection apparatus which is advantageous in improving an S/N ratio of a signal detected by a light-receiving element.

According to an aspect of the present invention, a detection apparatus includes an optical system including a polarization beam splitter and a quarter-wave plate; the optical system being configured to illuminate a mark via the polarization beam splitter and the quarter-wave plate in sequence, and to direct light reflected from the mark via the quarter-wave plate and the polarization beam splitter in sequence towards a light-receiving element. An airtight container configured to enclose therein at least part of the optical system includes, as a partition wall thereof, a light transmitting member arranged in an optical path between the polarization beam splitter and the quarter-wave plate.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to describe the principles of the invention.

FIGS. 1A and 1B are diagrams illustrating a configuration of a detection apparatus according to a first exemplary embodiment.

FIGS. 2A and 2B are diagrams illustrating a configuration of a detection apparatus as a comparative example.

FIG. 3 is a diagram illustrating a relationship between an incident angle of light and phase difference (retardation) on a λ/4 plate.

FIGS. 4A and B are diagrams illustrating a configuration of a detection apparatus according to a second exemplary embodiment.

FIGS. 5A and B are diagrams illustrating a configuration of a detection apparatus according to a third exemplary embodiment.

FIG. 6 is a diagram illustrating a configuration example of an exposure apparatus.

FIG. 7 is a diagram illustrating a configuration example of an electron beam drawing apparatus.

### DESCRIPTION OF THE EMBODIMENTS

Various exemplary embodiments, features, and aspects of the invention will be described in detail below with reference to the drawings.

In the detailed description, like reference numerals refer to like elements throughout all of the accompanying drawings and a repeated description thereof will be omitted.

A first exemplary embodiment will be described.

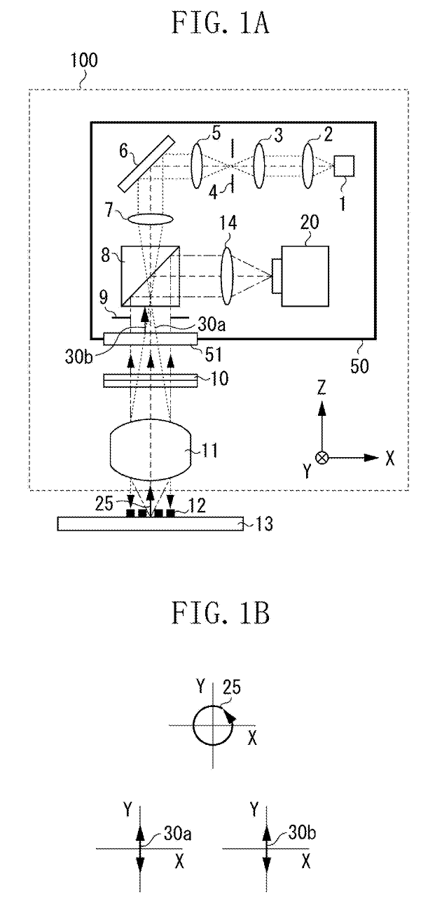

FIG. 1A is a diagram illustrating a configuration of a detection apparatus 100 according to the first exemplary embodiment. In the detection apparatus 100 an optical system detects a mark 12 provided on a substrate 13. The optical system includes an illumination system and an image forming system. The illumination system illuminates the mark 12 by light emitted from a light source 1; and the image forming system (light receiving system) forms an image of the illuminated mark 12. The illumination system is configured to include relay optical systems 2 and 3, an aperture stop 4, an illumination optical system 5, a mirror 6, a relay lens 7, a polarizing beam splitter (polarization beam splitter) 8, a λ/4 plate (quarter-wave plate or quarter-wavelength plate) 10, and an objective optical system 11. The illumination system illuminates the mark 12 via the components in the named sequence. Further, the image forming system includes the objective optical system 11, the λ/4 plate 10, the aperture stop 9, the polarizing beam splitter 8, and the image forming optical system 14. In this manner, the image forming system is configured to receive reflection light 25 from the mark 12 via the components in the named sequence to form an image in a sensor 20 (light-receiving element). Further, as illustrated in FIG. 1A, the detection apparatus 100 according to the first exemplary embodiment is configured to include an airtight container 50 having a glass plate 51 (a light transmitting member) as a partition wall.

In the detection apparatus 100, the light emitted from the light source 1 reaches the aperture stop 4 through the relay optical systems 2 and 3. In the aperture stop 4, a plurality of kinds of apertures is provided to be switched by a command from a control device (not illustrated) and a numerical aperture of illumination light (illumination system) may be modified (changed) in response to an aperture being switched for another. Light that passes through the aperture stop 4 is guided to the polarizing beam splitter 8 through the illumination optical system 5, the mirror 6, and the relay lens 7. Herein, in the polarizing beam splitter 8, P-polarized light polarized in parallel to a Y direction of FIG. 1A is transmitted and S-polarized light polarized in parallel to an X direction is reflected. As a result, the P-polarized light that is transmitted through the polarization beam splitter 8 passes through the aperture stop 9 and through the glass plate 51. Thereafter, the P-polarized light transmitted through the glass plate 51 is converted into circularly polarized light via the λ/4 plate 10. The circularly polarized light illuminates the mark 12 formed on the substrate 13 via the objective optical system 11 by the Kohler illumination method.

Light reflected (refracted and scattered) on the mark 12 passes through the objective optical system 11 and thereafter, is converted into S-polarized light from the circularly polarized light via the λ/4 plate 10. The S-polarized light is transmitted through the glass plate 51 and thereafter, reaches the aperture stop 9. Herein, a polarization state of the light 25 reflected on the mark 12 becomes circularly polarized light in a reverse direction to the circularly polarized light before reflection. That is, if the reflection light 25 is right-hand circularly polarized light before reflection, the reflection light 25 becomes left-hand circularly polarized light after reflection. Further, the aperture stop 9 switches the numerical aperture of image forming light (image forming system) by changing a diaphragm diameter with a command from a control device (not illustrated). Light that passes through the aperture stop 9 is reflected on the polarizing beam splitter 8 and thereafter, guided to the sensor 20 via the image forming optical system 14. In this manner, an optical path of the illumination light to illuminate the substrate 13, and an optical path of the reflection light 25 from the substrate 13 are separated from each other by the polarizing beam splitter 8, and an image of the mark 12 provided on the substrate 13 is formed on the sensor 20.

In the detection apparatus according to the present exemplary embodiment, the airtight container 50 having the glass plate 51 covers part of the detection apparatus 100. The glass plate 51 is arranged on an optical path between the polarizing beam splitter 8 and the λ/4 plate 10. As a result, a degree, to which reflected light 30b from the glass plate 51 causes the S/N ratio of the detection signal obtained by the sensor 20 to deteriorate, is reduced. Therefore, a degree, to which the reflected light 30b causes accuracy or precision of measuring the position of the mark based on the detection signal to deteriorate, is reduced. This point will be described below in detail.

The airtight container 50 covers (contains) a part of the detection apparatus 100 to separate an atmospheric environment, such as atmospheric pressure, a temperature, a humidity, a gas component, and the like, in the detection apparatus 100 from an external vacuum environment by the glass plate 51.

In the detection apparatus 100 according to the present exemplary embodiment, it is configured such that the light source 1 as a heat generating source and the sensor 20 are covered and separated by the airtight container 50 to reduce an influence by thermal deformation in the constituent members. For example, processing or assembling the Kohler illumination objective optical system 11 requires higher precision than other optical elements, and thermal deformation in the objective optical system 11 exerts a large influence on measurement accuracy by the detection apparatus 100. As a result, in the detection apparatus 100 of FIG. 1A, the light source 1 and the sensor 20 are covered with the airtight container 50 to reduce heat transferred to the objective optical system 11 and to reduce the influence of heat on measurement accuracy. Herein, in the airtight container 50, an air conditioning (cooling) mechanism is configured to maintain the temperature within an allowable range. Further, a temperature adjusting mechanism in which a heat generating portion is cooled by liquid cooling, as well as air conditioning (air cooling) may be provided.

The light transmitting glass plate 51 is, for example, a parallel plane plate and it is advantageous that the glass plate 51 has a thickness with which deformation of the glass plate 51 accompanied by an atmospheric pressure difference between environments inside and outside the airtight container 50 is negligible. However, when a thickness is limited by a layout space or due to other design parameters, and thus the glass plate 51 is deformed, the optical system may be designed in advance to correct an aberration caused by the deformation. To that end, a deformation amount is obtained by simulation by a finite element method or actual measurement by a laser interferometer. The aberration may be corrected by selecting a curvature, a thickness, a glass material, and the like of a lens. Accordingly, the glass plate 51 is not limited to a parallel plane plate and may include other light transmitting members such as a prism or a lens and may be a combination of several light transmitting members.

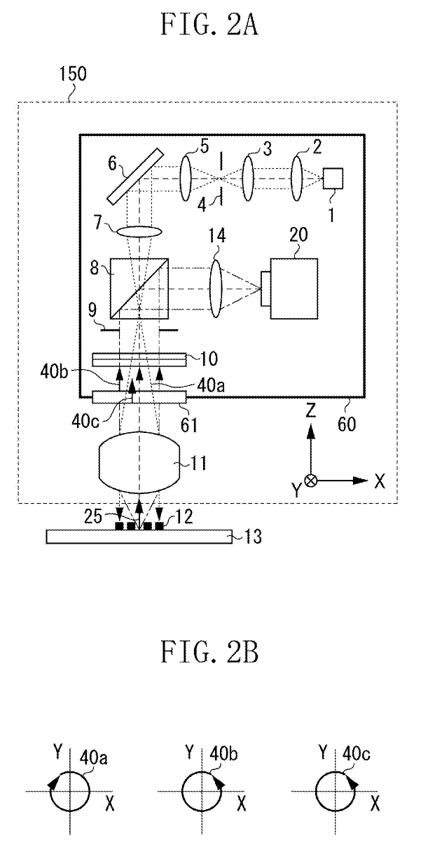

Turning now to FIG. 2, a case in which measurement accuracy can deteriorate by reflection light 40b, 40c from a glass plate 61 will be described, as a comparative example.

FIG. 2A is a diagram illustrating a configuration of a detection apparatus 150 as a comparative example. The detection apparatus 150 of FIG. 2A is different from the detection apparatus 100 of FIG. 1A in positional relationship between the λ/4 plate 10 and the glass plate 61, but in other aspects it includes the same elements as the detection apparatus 100. Specifically, in the comparative example of FIG. 2A, the λ/4 plate 10 is disposed inside the air tight container 60 in which the glass plate 61 forms a wall.

In general, in a parallel glass plate, even when each surface is coated for anti-reflection, approximately 0.1% reflection within incident light may occur due to a manufacturing tolerance. As a result, when the light reflected on the glass plate is detected by the sensor, the S/N ratio of the detection signal decreases as compared with a case where only the reflected light from the mark is detected.

FIG. 2B illustrates polarization states of light 40a incident on the glass plate 61 before reflection, and lights 40b and 40c reflected on a front surface and a rear surface of the glass plate 61, respectively, in the detection apparatus 150 of FIG. 2A. In the detection apparatus 150 of FIG. 2A, light converted into the circularly polarized light 40a via the λ/4 plate 10 reaches the glass plate 61. Therefore, the polarization state of the light 40a incident in the glass plate 61 is the right-hand circularly polarized light, and the polarization state of the lights 40b and 40c reflected on the front surface and the rear surface of the glass plate 61 all becomes the left-hand circularly polarized light. The lights 40b and 40c reflected on the glass plate 61 are transmitted through the λ/4 plate 10, and thus converted from the circularly polarized light into the S-polarized light via the λ/4 plate 10. The S-polarized lights 40b and 40c are reflected by the polarizing beam splitter 8 and guided to the sensor 20 via the image forming optical system 14. That is, since the polarization state of the reflection lights 40b and 40c from the glass plate 61 becomes the left-hand circularly polarized light that is the same polarization state as the reflection light 25 from the mark 12 of the substrate 13, the reflected lights 40b and 40c are reflected by the polarizing beam splitter 8 to reach the sensor 20. Therefore, in the configuration of the detection apparatus 150, the reflected lights 40b and 40c from the glass plate 61 and the reflected light 25 from the mark 12 may not be split from each other, and since both lights are detected by the sensor 20, it affects negatively the S/N ratio of the detection signal.

In the comparative example of FIGS. 2A and 2B, the S/N ratio of the detection signal is decreased because the reflected light from the glass plate and the reflected light from the mark are in the same polarization state, and cannot be split by the polarizing beam splitter, as described above. Therefore, to reduce the decrease of the S/N ratio of the detection signal, the reflected light from the glass plate and the reflected light from the mark may be caused to be in different polarization states to be split from each other.

In the detection apparatus 100 according to the exemplary embodiment illustrated in FIG. 1A, the components of the detection apparatus other than the λ/4 plate 10 and the objective optical system 11 are covered with the airtight container 50 and the glass plate 51 is arranged on an optical path between the polarizing beam splitter 8 and the λ/4 plate 10. As a result, the reflected light 30b from the glass plate 51 and the reflected light 25 from the mark 12 are caused to be in different polarization states and split from each other, so that the decrease in the S/N ratio by the reflected light 30b from the glass plate 51 is reduced. Further, light can be respectively reflected on a front surface and a rear surface of the glass plate 51, but polarization states of both reflected light are the same as each other, and as a result, herein, the light respectively reflected on the front surface and the rear surface of the glass plate 51 will be jointly described as 30b for simplified description.

FIG. 1B illustrates respective polarization states of the light 30a emitted from the light source 1 to be incident in the glass plate 51, the light 30b reflected by the glass plate 51, and the light 25 reflected by the mark 12, in the detection apparatus 100 of FIG. 1A. In the detection apparatus 100 of FIG. 1A, the light emitted from the light source 1 becomes P-polarized light polarized in parallel to a Y direction through the polarizing beam splitter 8 and thereafter, reaches the glass plate 51 via the aperture stop 9. As a result, both the polarization states of the light 30a incident in the glass plate 51 and the light 30b reflected by the glass plate 51 are P-polarized light. Herein, as described above, the light 25 (circularly polarized light) reflected by the mark 12 is converted into the S-polarized light by the λ/4 plate 10 and thereafter, reflected by the polarizing beam splitter 8 to reach the sensor 20. That is, the polarization states of the reflected light 30b on the glass plate 51 and the reflected light 25 on the mark 12, which reach the polarization beam splitter 8, become the P-polarized light and the S-polarized light, respectively. As a result, the polarizing beam splitter 8 can split (separate) the P-polarized light 30b reflected from the glass plate 51 and the light 25 reflected from the mark 12. Accordingly, a decrease in the S/N ratio of the detection signal due to light 30b reflected from the glass plate 51 does not occur.

Subsequently, a layout of the λ/4 plate 10 will be described. In the above configuration, the λ/4 plate 10 is arranged on an optical path between the polarizing beam splitter 8 and the objective optical system 11.

However, the λ/4 plate 10 may be arranged on an optical path between the objective optical system 11 and the substrate 13. In this configuration, although the P-polarized light incident in the objective optical system 11 is reflected on the objective optical system 11, the reflected light is the P-polarized light and thus the polarization beam splitter 8 transmits the reflected light. Accordingly, further effect of reducing the decrease in the S/N ratio by the reflected light in the objective optical system 11 is provided.

However, when one intends to arrange the λ/4 plate on the optical path between the objective optical system 11 and the substrate 13, it is necessary to note two points of (A) deviation of retardation and (B) limitation of layout space. The two points will be described.

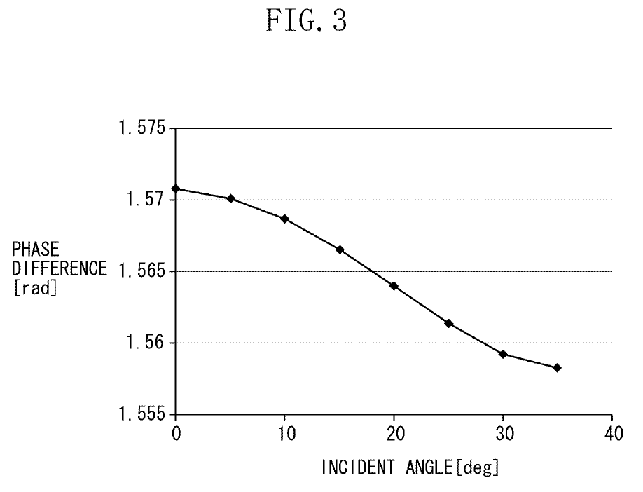

In general, in the detection apparatus, the numerical aperture of the objective optical system on the substrate side needs to be a large value (for example, equal to or more than 0.4) to secure resolving power and a light amount. As a result, an incident angle of light in the objective optical system 11 from the substrate 13 is larger than an incident angle of light in another optical system. Herein, FIG. 3 illustrates a relationship between an incident angle to the λ/4 plate and retardation (phase difference) obtained by the λ/4 plate. FIG. 3 illustrates a result of calculating retardation when light having a wavelength of 546 nm is incident on the λ/4 plate at a plurality of incident angles. The λ/4 plate is obtained by laminating two sheets of crystals. From FIG. 3, retardation when the incident angle of light to the λ/4 plate is 0° is π/2, and as the incident angle increases, the retardation decreases. As a result, when the λ/4 plate 10 is disposed on the optical path between the objective optical system 11 having a large numerical aperture (NA) and the substrate 13, variation in the retardation, that is, variation in the polarization state of the light becomes larger. This causes the S/N ratio of the detection signal to be decreased, and as a result, attention is required.

Next, the layout space will be described. A working distance (WD) between the objective optical system 11 and the substrate 13 is, for example, approximately several mm to dozen mm. As a result, it is difficult to arrange the λ/4 plate 10 having a thickness of several mm on the optical path between the objective optical system 11 and the substrate 13. That is, there is a drawback in that a possibility increases, in which the detection apparatus will collide with a stage (not illustrated) or a substrate arranged thereon. Further, in general, a difficulty level in designing or manufacturing the detection apparatus increases to increase the WD between the objective optical system 11 and the substrate 13, which is disadvantageous in terms of a cost.

From the above two points, it is difficult to arrange the λ/4 plate 10 on the optical path between the objective optical system 11 and the substrate 13. In contrast, the incident angle of the light is small and the limitation of layout space is small, on the optical path between the polarization beam splitter 8 and the objective optical system 11. Therefore, it is advantageous that the λ/4 plate 10 is arranged on the optical path between the polarizing beam splitter 8 and the objective optical system 11.

The configuration according to the exemplary embodiment is not limited to the aforementioned configuration example. For example, the light emitted from the light source 1 may be reflected by the polarizing beam splitter 8 to illuminate the substrate 13 and the light reflected by the mark 12 may be transmitted through the polarizing beam splitter 8 to reach the sensor. Further, for example, combinations of a plurality of image forming optical systems having different magnifications and sensors may be arranged and the optical path may be switched to detect an image of the mark 12 at a needed magnification.

The detection apparatus according to the exemplary embodiment is advantageous in terms of improving the S/N ratio of the detection signal to thereby contribute to a high-accuracy measurement of an alignment mark position.

A second exemplary embodiment will be described.

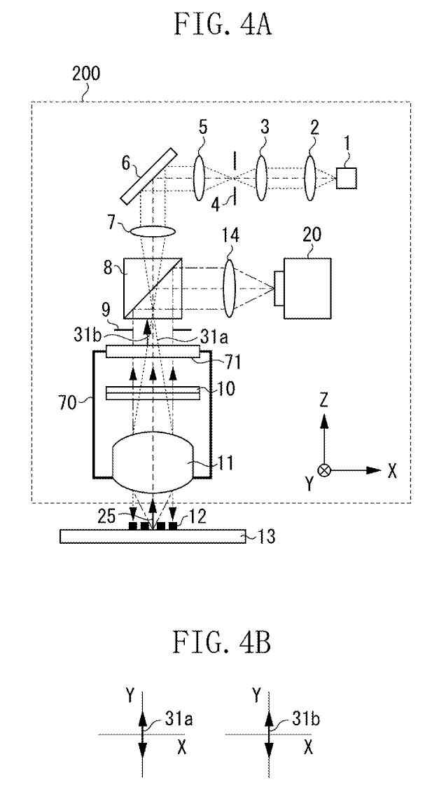

Referring to FIG. 4, a detection apparatus according to the second exemplary embodiment will be described. FIG. 4A is a diagram illustrating a configuration of a detection apparatus 200 according to the second exemplary embodiment. The present exemplary embodiment is characterized in a configuration of an airtight container 70 and has the same configuration as the first exemplary embodiment in other parts.

In the detection apparatus 200 of FIG. 4A, the λ/4 plate 10 is covered with the airtight container 70 having the light transmitting objective optical system 11 and a glass plate 71. The components of the detection apparatus 200 are spatially divided to reduce an influence of a contamination material or a change in optical performance. Further, the present exemplary embodiment is the same as the first exemplary embodiment in that the glass plate 71 of the airtight container 70 is arranged on the optical path between the polarization beam splitter 8 and the λ/4 plate 10 to prevent or minimize a decrease in the S/N ratio of the detection signal caused by the reflected light 31b from the glass plate 71.

FIG. 4B illustrates a polarization state of the light 31a emitted from the light source 1 to be incident in the glass plate 71 and a polarization state of the light 31b reflected by the glass plate 71, in the detection apparatus 200 of FIG. 4A. As in the previous examples, light may be respectively reflected on a front surface and a rear surface of the glass plate 71, but polarization states of both surfaces are the same, and therefore, herein, both polarization states will be jointly described as 31b for simplification. In the detection apparatus 200, the light emitted from the light source 1 becomes P-polarized light polarized in parallel to the Y direction through the polarizing beam splitter 8 and thereafter, reaches the glass plate 71 via the aperture stop 9. Therefore, both the polarization states of the light 31a incident in the glass plate 71 and the light 31b reflected by the glass plate 71 are the P-polarized light. Accordingly, the P-polarized light 31b reflected by the glass plate 71 is transmitted through the polarizing beam splitter 8 and thus does not reach the sensor 20. As such, in the detection apparatus 200 of the second exemplary embodiment, the reflected light 31b from the glass plate 71 can be separated from the reflected light 25 from the mark 12, so that the S/N ratio of the detection signal is high.

Next, the airtight container 70 will be described. In the exemplary embodiment, the airtight container 70 includes the light transmitting objective optical system 11 and the glass plate 71 as the partition wall and covers the λ/4 plate 10. Herein, in the objective optical system 11, a plurality of lenses bonded by using an adhesive may be used to correct a chromatic aberration of the optical system. The adhesive may discharge a contamination material under a vacuum environment and thus may contaminate the component. Further, there is a concern that the atmospheric pressure will vary and the optical performance will be changed. As a result, for example, the inside of the airtight container 70 is made under an atmospheric environment. As such, by separating the environments inside and outside the airtight container 70 from each other, the discharge of the contamination material from the objective optical system 11 or the influence of the change in performance of the optical system can be reduced.

Further, the reason that the airtight container 70 has the objective optical system 11 as the partition wall is the limitation of the layout space between the objective optical system 11 and the substrate 13, which is described in the first exemplary embodiment. As described in the first exemplary embodiment, since the WD between the objective optical system 11 and the substrate 13 is approximately in the range of several mm to dozen mm, it is difficult to arrange a glass plate having a thickness of several mms on the optical path between the objective optical system 11 and the substrate 13. In addition, when the glass plate is arranged as above, there is also a drawback in that there is a possibility that the stage (not illustrated) or the substrate will collide with the detection apparatus (glass plate).

Further, when the objective optical system 11 includes a plurality of sheets of lenses, the airtight container 70 may be configured to have a lens closest (furthest from the polarizing beam splitter) to the substrate 13 in the objective optical system 11 as the partition wall. However, in some cases, the airtight container 70 may have a lens other than the lens closest to the substrate 13 among the plurality of lenses constituting the objective optical system 11 as the partition wall. In this case, the discharge of the contamination material or the change in optical performance by a part of the objective optical system 11 arranged outside the airtight container 70 needs to be slight. Further, as an additional configuration example, the airtight container 70 may have two lenses from among the objective optical system 11 respectively used as the partition walls. In this case, since there is a limitation in adjusting an interval between two lenses provided in the airtight container 70, the airtight container 70 may have two lenses only when the limitation is allowed. A configuration for at least one of air-conditioning and temperature adjustment in the airtight container 70 is the same as the case of the first exemplary embodiment.

A third exemplary embodiment will be described.

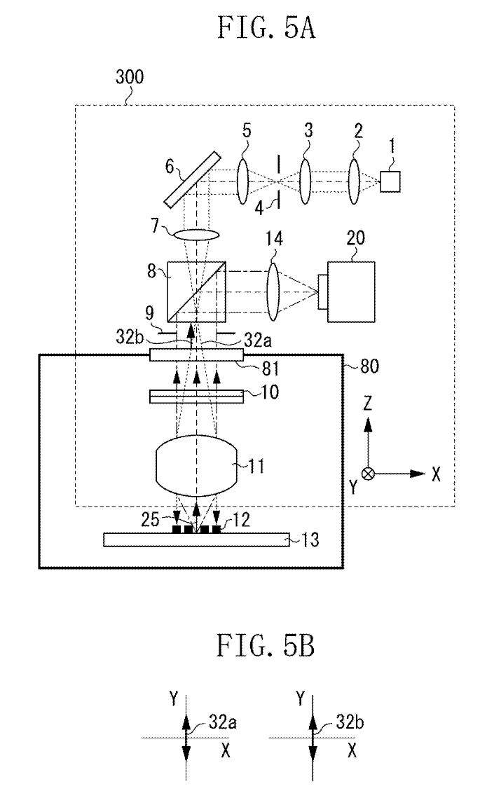

Referring to FIG. 5, a detection apparatus according to the third exemplary embodiment will be described. FIG. 5A is a diagram illustrating a configuration of a detection apparatus 300 according to the exemplary embodiment. The exemplary embodiment is characterized in a configuration of an airtight container 80 that covers a part of the optical system and may have the same configuration as the first exemplary embodiment or the second exemplary embodiment in other parts.

In the detection apparatus 300 of the exemplary embodiment illustrated in FIG. 5A, the airtight container 80 includes a light transmitting glass plate 81 and covers the λ/4 plate 10, the objective optical system 11, the substrate 13, and a (substrate) stage (not illustrated) that holds the substrate 13. As a result, the light source 1 which is the heat generating source or the sensor 20 and the objective optical system 11 or the substrate 13 are separated from each other to reduce thermal deformation in components that influence the measurement accuracy. Further, the detection apparatus 300 of the exemplary embodiment are the same as those of the first exemplary embodiment and the second exemplary embodiment in that the glass plate 81 provided in the airtight container 80 is arranged on the optical path between the polarization beam splitter 8 and the λ/4 plate 10.

FIG. 5B illustrates a polarization state of the light 32a emitted from the light source 1 to be incident in the glass plate 81 and a polarization state of the light 32b reflected by the glass plate 81 to reach the polarizing beam splitter 8, in the detection apparatus 300 of FIG. 5A. Further, since polarization states of light reflected on a front surface and light reflected on a rear surface of the glass plate 81 are the same as each other, the light will be jointly described as the light 32b. In the detection apparatus 300 of FIG. 5A, the light emitted from the light source 1 becomes P-polarized light polarized in parallel to the Y direction through the polarizing beam splitter 8 and thereafter, reaches the glass plate 81 via the aperture stop 9. Therefore, both the polarization states of the light 32a incident in the glass plate 81 and the light 32b reflected by the glass plate 81 are the P-polarized light. Accordingly, the P-polarized light 32b reflected by the glass plate 81 is transmitted through the polarizing beam splitter 8, but does not reach the sensor 20. Therefore, it is advantageous in an S/N ratio of the detection signal.

Further, the airtight container 80 having the glass plate 81 covers the λ/4 plate 10, the objective optical system 11, and the substrate 13. As a result, the light source 1 which is the heat generating source or the sensor 20 and the objective optical system 11 or the substrate 13 can be spatially separated from each other to reduce thermal deformation in components that influence measurement accuracy of a mark position based on an output of the detection apparatus.

In addition, when the influence by the discharge of the contamination material by the objective optical system 11 or the change in optical performance is significantly small, the airtight container 80 may be configured as a vacuum container.

### Application Example of Detection Apparatus to Lithography Apparatus, and the Like

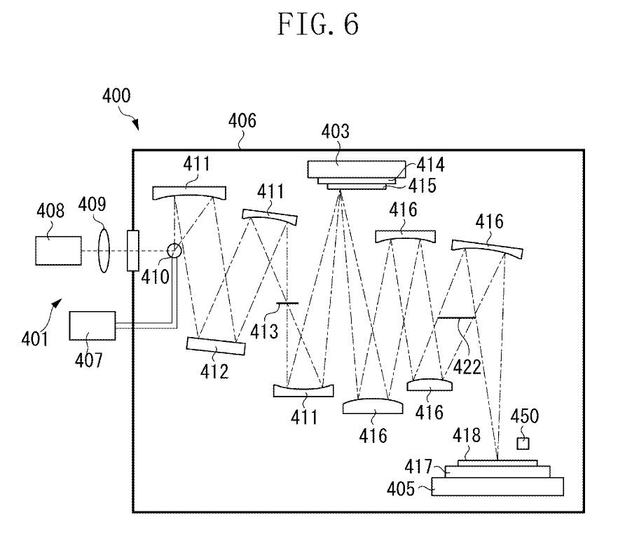

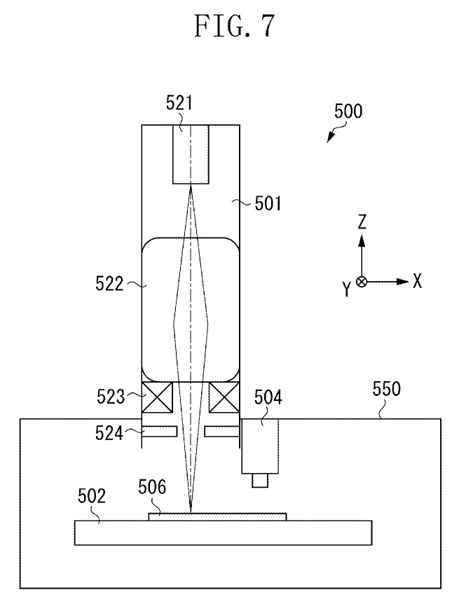

Referring to FIGS. 6 and 7, an exemplary embodiment of a case in which the aforementioned detection apparatus is applied to the lithography apparatus, and the like will be described.

First, referring to FIG. 6, a configuration example of an exposure apparatus 400 as the lithography apparatus will be described. The exposure apparatus 400, which transfers a pattern to an object under the vacuum environment, includes a light source 401, an illumination optical system 402, a reticle stage 403, a projection optical system 404, a wafer stage 405, and a vacuum chamber (vacuum container) 406 that covers the components. The light source 401 includes, for example, a target providing unit 407 and an excitation pulse laser generating unit 408. A pulse laser is irradiated to a target material provided into the vacuum chamber 406 via a condenser lens 409 to generate plasma 410 and irradiate EUV light. Further, atmospheric pressure in the vacuum chamber 406 is maintained at, for example, 10⁻⁴ to 10⁻⁵ Pa. The illumination optical system 402 includes a plurality of mirrors (a multilayer mirror or an oblique-incidence mirror) 411, an optical integrator 412, and an aperture 413 and illuminates the reticle 415 with the irradiated EUV light. The projection optical system 404 includes a plurality of mirrors 416 and an aperture 422 and projects the EUV light reflected by the reticle 415 to a wafer 418 (a substrate or an object) held by the wafer stage 405.

In the exposure apparatus 400, a detection apparatus 450 is provided to measure the position of an alignment mark formed on at least one of the wafer 418, the reticle 415, and the wafer stage 405. Any one of the aforementioned detection apparatuses 100, 200, and 300 may be applied to the detection apparatus 450. Therefore, the position of the alignment mark can be measured with high accuracy by using the detection apparatus 450 to thereby provide the lithography apparatus that is advantageous in terms of overlay accuracy.

As another example of the lithography apparatus or an example of another apparatus, there is a charged particle beam apparatus that processes an object with charged particle beam. The charged particle beam apparatus is represented by, for example, an electron beam drawing (exposure) apparatus, an ion beam drawing (exposure) apparatus, an electron beam microscope, and the like and may include various apparatuses for manufacturing, processing, measuring, and examining an article. Herein, referring to FIG. 7, a configuration example of an electron beam drawing apparatus 500 that performs drawing on a substrate (object) by using electrons as charged particles, will be described. The electron beam drawing apparatus 500, which transfers the pattern to the object under the vacuum environment, is configured to include an electron gun 521, an electron optical system 501, an electron detector 524, a wafer stage 502, a detection apparatus 504, and a vacuum chamber (vacuum container) 550. The inside of the vacuum chamber 550 is exhausted by a vacuum pump (not illustrated). In addition, the electron gun 521, the electron optical system 501, the electron detector 524, the wafer stage 502, and the detection apparatus 504 are arranged in the vacuum chamber 550. The electron optical system 501 is configured to include an electron lens system 522 that converges the electron beam from the electron gun 521 and a deflector 523 that deflects the electron beam. In addition, the electron gun 521, the electron optical system 501, and the electron detector 524 are controlled by a control unit (not illustrated).

In the electron beam drawing apparatus 500, the detection apparatus 504 is provided to measure the position of the alignment mark formed on the wafer 506 or the wafer stage 502. Any one of the aforementioned detection apparatuses 100, 200, and 300 may be applied to the detection apparatus 504. Therefore, the position of the alignment mark can be measured with high accuracy by using the detection apparatus 504 to thereby provide the lithography apparatus that is advantageous in terms of overlay accuracy.

As described above, according to the exemplary embodiment, it is possible to provide an apparatus that is advantageous in positioning the object.

### Exemplary Embodiment of Article Manufacturing Method

An article manufacturing method according to an exemplary embodiment is suitable to manufacture, for example, an article such as a micro device such as a semiconductor device, and the like or an element having a fine structure, and the like. The manufacturing method may include a process (a process of transferring (exposing or drawing) the pattern to the object) of forming a latent pattern by using the above described lithography apparatus in an object (for example, a substrate having a photosensitive agent on the surface) and a process of developing the object formed with the latent pattern in the corresponding process. Further, the manufacturing method may include other known processes (oxidizing, film forming, deposition, doping, planarization, etching, resist peeling, dicing, bonding, packaging, and the like). The article manufacturing method according to the exemplary embodiment is more advantageous than the method in the related art in terms of at least one of performance, quality, productivity, and production cost of the article.

As described above, although the exemplary embodiments of the present invention have been described, the present invention is not limited to the exemplary embodiments and various modifications or changes can be made within the scope of the spirit. For example, a detection apparatus having both the airtight container 50 of the first exemplary embodiment and the airtight container 70 of the second exemplary embodiment or the airtight container 80 of the third exemplary embodiment may be provided.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims the benefit of Japanese Patent Application No. 2012-085725, filed Apr. 4, 2012, which is hereby incorporated by reference herein in its entirety.

What is claimed is:

1. A detection apparatus, comprising:
an optical system including a polarization beam splitter and a quarter-wave plate, the optical system being configured to illuminate a mark via the polarization beam splitter and the quarter-wave plate in sequence, and to direct light reflected from the mark via the quarter-wave plate and the polarization beam splitter in sequence towards a light-receiving element; and
an airtight container configured to enclose therein at least part of the optical system, the airtight container including, as a partition wall thereof, a light transmitting member arranged in an optical path between the polarization beam splitter and the quarter-wave plate.

2. The apparatus according to claim 1, wherein the light transmitting member includes a parallel plane plate.

3. The apparatus according to claim 1, wherein the airtight container contains, as the part of the optical system, the polarization beam splitter, a light source which emits light for illuminating the mark, and the light-receiving element which receives the light reflected from the mark.

4. The apparatus according to claim 1, wherein the optical system includes an objective optical system arranged further or closer from the polarization beam splitter than the quarter-wave plate, and the light transmitting member includes at least a part of the objective optical system.

5. The apparatus according to claim 4, wherein the light transmitting member includes a lens furthest from the polarization beam splitter in the objective optical system.

6. The apparatus according to claim 1, wherein the airtight container contains the quarter-wave plate.

7. The apparatus according to claim 1, wherein the airtight container contains a stage in which the mark is arranged, an objective optical system included in the optical system, and the quarter-wave plate.

8. A lithography apparatus for transferring a pattern to an object under a vacuum environment, the apparatus comprising
the detection apparatus defined in claim 1 and configured to detect a mark for positioning the object.

9. A charged particle beam apparatus for processing an object under a vacuum environment, the apparatus comprising
the detection apparatus defined in claim 1 and configured to detect a mark for positioning the object.

10. A method of manufacturing an article, the method comprising:
transferring a pattern to an object using a lithography apparatus; and
processing the object, to which the pattern has been transferred, to manufacture the article,
wherein the lithography apparatus transfers the pattern to the object under a vacuum environment, the lithography apparatus including
a detection apparatus is configured to detect a mark for positioning the object, the detection apparatus including:
an optical system including a polarization beam splitter and a quarter-wave plate, the optical system being configured to illuminate the mark via the polarization beam splitter and the quarter-wave plate in sequence, and to direct light reflected from the mark via the quarter-wave plate and the polarization beam splitter in sequence towards a light-receiving element; and
an airtight container configured to enclose therein at least part of the optical system, the airtight container including, as a partition wall thereof, a light transmitting member arranged in an optical path between the polarization beam splitter and the quarter-wave plate.
